(19) United States
(12) Patent Application Publication
(10) Pub. No.: US 2015/0330828 A1
(43) Pub. Date: Nov. 19, 2015

(54) Wireless Fluid Sensor

(71) Applicant: Arthur E. Colvin, JR., Mt. Airy, MD (US)

(72) Inventor: Arthur E. Colvin, JR., Mt. Airy, MD (US)

(21) Appl. No.: 14/713,285

(22) Filed: May 15, 2015

Related U.S. Application Data
(60) Provisional application No. 61/993,572, filed on May 15, 2014.

(51) Int. Cl. G01F 23/38

(52) U.S. Cl. CPC G01F 23/38

(57) ABSTRACT

A fuel-gauge system detects the angular position of a float-based fluid-level-detecting mechanism's magnet and determines the level of liquid fuel remaining within a cylinder. The system wirelessly transmits to an app or application running on a multipurpose, consumer computing device fuel-remaining information, either in terms of percentage of maximum fluid level or, preferably, in terms of actual fluid volume remaining. The system determines fluid temperature and compensates for variation in the fluid-level attributable to temperature fluctuation.

### CROSS-REFERENCE TO RELATED APPLICATION

This application is based on and claims the priority benefit of U.S. provisional application No. 61/993,572 filed May 15, 2014, the contents of which are incorporated herein by reference.

### FIELD OF THE INVENTION

In general, the invention relates to devices used to measure fluid remaining within a container. (As used herein, the term “fluid” refers specifically to a liquid.) More particularly, the invention relates to float-based fluid-measuring devices.

### BACKGROUND OF THE INVENTION

A variety of float-based fluid-level gauges, which convert the up-and-down motion of a float riding on the surface of fluid in a container to rotary motion of a dial-type gauge to indicate the level (i.e., height) of fluid in the container, are known in the art. (As used herein, the term “level” refers to the height within the container of the fluid's surface.) For example, a simple gasoline gauge used on outdoor power equipment such as lawnmowers has a twisted length of flat metal extending from the underside of the fuel cap. The length of metal passes longitudinally through the center of a disc-shaped or cylindrical float, which is able to slide along the length of metal, and the length of metal is supported by the fuel cap in a manner that permits the length of metal to rotate about its longitudinal centerline. A pointer or needle that is visible from the exterior of the fuel cap is fixed to the upper end of the length of metal. Because the float is restrained from rotating, e.g., by guide rails located at diametrically opposite sides of the float, the twist in the length of metal causes the length of metal—and hence the pointer—to rotate as the float slides up and down along the length of metal. In this manner, the level (i.e., height) of gasoline within the fuel tank can be indicated.

Of greater relevance to the present invention are float-based gauges used to indicate the level of liquid propane within storage containers of the sort used to supply propane (as fuel) to houses or other buildings. Such containers are most often cylindrical pressure vessels manufactured according to ASME (American Society of Mechanical Engineers) standards, and they are frequently provided in 100-gallon, 250-gallon, 500-gallon, and 1000-gallon capacities. Furthermore, multiple such containers frequently are installed and joined together to provide even greater fuel-supply capacities.

In general, the fluid-level gauges most commonly used with such liquid-propane supply cylinders—particularly in residential settings—are configured as disclosed, for example, in U.S. Pat. No. 2,992,560. In this type of fluid-level gauge, as illustrated in FIGS. 1 and 2, a float mechanism 10 is located within and extends downwardly from the top portion of propane cylinder 12, and a gauge head dial 14 is located outside of and securely attached to the cylinder 12 with the cylinder 12 being pressure-sealed. The float mechanism 10 has a float 16 located at one end of float arm 18, and typically a counterweight 20 located at the other end of float arm 18. Float 16 “rides” on the surface 22 of liquid propane 24 contained within the cylinder 12. The float arm 18 is attached to a toothed wheel or bevel gear 26, which rotates in a vertical plane as the float 16 rises and falls with the level of liquid propane 24 in the cylinder 12.

The toothed wheel or bevel gear 26, in turn, is engaged with and drives pinion gear 28, which rotates in a horizontal plane. Pinion gear 28 is attached to the lower end of driveshaft 30, which extends upwardly toward the gauge head dial 14 of the fluid-level sensor assembly. A disc-shaped drive magnet 32 is fixedly attached to the top of the driveshaft 30 and is located within a space (not labeled) within tank flange 34, which is formed from non-ferromagnetic material. (Tank flange 34 extends through the wall of the cylinder 12.)

Exterior to the cylinder 12, a needle indicator 36 is supported on a vertical axle (not labeled) so as to rotate in a horizontal plane, and a disc-shaped “slave” magnet 38 is attached to and surrounds the vertical axle. The drive magnet 32 and the slave magnet 38 are magnetically coupled to each other across the non-ferromagnetic, intervening wall structure of the tank flange 34 (and hence through the wall of the cylinder 12); therefore, as the driveshaft 30 rotates with rising and falling levels of the liquid propane 24 in the cylinder 12, the needle indicator 36 will also rotate and provide an indication as to the level of the liquid propane 24 within the cylinder 12. A transparent cap or cover 40 covers the needle indicator 36 to protect it from the elements, and a dial-type scale to indicate fluid levels may be provided on a printed disc (not shown) located beneath the needle indicator 36 or etched into the cap 40.

Despite its general prevalence in connection with liquid propane cylinders, this configuration of a fluid-level gauge has a number of shortcomings. In particular, it relies on a manual (i.e., visual) reading to determine the level of liquid propane in the cylinder. Because propane levels typically need to be checked more frequently in winter—when propane is being used to heat a home or other building—than they need to be checked in summer, checking fluid levels often requires the person doing so to trudge through ice and snow to access the cylinder, which many times is located in a remote area of one's property, e.g., behind bushes or other foliage. The cylinder also might be located substantially underground, which can further impede access to the cylinder and its gauge under snow and ice.

To address this accessibility issue, at least one company provides a system to transmit fluid-level information to a dedicated receiver located, e.g., inside one's home, as illustrated in Lease, U.S. Pat. No. 7,441,569. According to this system, a specially configured magnetic sensing head mates with a correspondingly configured, specially configured recess in the gauge's dial lens (i.e., the gauge cover), and a cable leads from the magnetic sensing head to a separate transmitter unit. The transmitter unit transmits fluid-level information to a specially configured, dedicated base unit that may be located within the home, and the base unit displays fluid level information. Given the number of specially configured components this system uses, however, it is not very adaptable; it is not inexpensive; and it is not very user-friendly. It also appears to require one transmitter/receiver pair per cylinder, which further increases cost.

Additionally, as noted, the unit provides fluid-level indication. But that is not linearly equivalent to (i.e., easily understandably) the actual amount of fluid remaining in the cylinder (i.e., volume in units such as gallons or liters) due to the circular nature of the cylinder, including its endwalls. In particular, if the horizontal cylinder is exactly half-full of liquid propane (i.e., a fluid level of 50%), a decrease in the level of the liquid on the order of 4% or 5% will, in fact, correspond to a decrease in the amount of liquid in the cylinder that is on the order of 4% or 5% because at that general level of the liquid, the walls of a large cylinder are vertical (i.e., right at the 50% level) or are very close to vertical, and the sectional area of the fluid at that level will decrease only slightly as the fluid level drops. However, as the fluid level decreases below 50%, the walls of the cylinder curve inwardly; therefore, the volume of each differential “slice” of fluid at each successively lower level decreases with decreasing sectional area of the differential “slice” at a faster and faster, sinusoidal rate. As a result, a drop in fluid level from, say, 20% to 15% of maximum fluid level will have a significantly greater effect in terms of the percentage of fuel remaining than just 5%, which effect a fuel gauge that outputs information in terms of fluid level—not volume or amount—simply cannot convey to the average consumer. Thus, a consumer who thinks he or she has, say, 100 gallons of propane remaining because the gauge on a 1000-gallon cylinder reads 10% may, in actuality, be very close to running out of fuel; in the middle of winter, when the need for heating fuel is at its highest, running out of fuel could be disastrous.

Given this “mismatch” between percentage of maximum fluid level remaining and actual amount of fluid remaining, it is perhaps not surprising that most propane vendors recommend refilling one's cylinders when the level reaches 20%-25%. But the cost of propane varies significantly with demand depending on the season. (In Maryland, for example, the price of propane varied from $2.20 per gallon to $5.75 per gallon during the 2012/2013 season, and it varied from $3.12 per gallon to $7.73 per gallon during the 2013/2014 season.) Therefore, the lack of clear knowledge as to how much fuel one actually has remaining often causes consumers to refill their cylinders before it is actually necessary to do so, and often at a greater expense than would be the case if the consumers knew clearly how much fuel they had remaining and could wait until prices dropped even partially with seasonal fluctuation before refueling.

Moreover, the physiochemical properties of liquid propane create additional uncertainties for the user due to ambient surrounding and tank temperature and the significant expansion and contraction of the liquid fuel within it. In particular, fuel levels can appear to change significantly with changing temperature, without actually changing the actual total amount of useable fuel stored within the tank, as warmer temperatures cause more and more propane to transition into the vapor phase. This effect can cause a consumer, thinking that he or she has less useable fuel available than is actually the case, to refill prematurely and at a higher cost.

Further still, the needle indicator assembly typically found at least in conventional residential fluid-level gauges is often made inexpensively using molded plastic encasements of small diameters and dial resolution, which does not have sufficient diameter and arc to indicate more than crude increments of fluid level, e.g., ¼ maximum level, ½ maximum level, ¾ maximum level, or 100% maximum level. Given the propensity for inexpensive plastic parts to stress due to extremes of weathering throughout the year; temperature; sunlight; humidity shifts, and, for example, due to poor tolerances, the practical error inherent in a reading taken with such a gauge—on the order of 10% to as much as +/−30%—can be significant. Also, sometimes a breach in a mold seam can allow water vapor into the dial encasement, where it can then freeze and lock up the dial completely. Further still, it can be difficult for an average-height human to access the gauge on larger tanks, which gauges typically are located at the top of the arc on a horizontal cylinder, in a way that permits the gauge to be visually viewed and read straight-on, e.g., from above. That limitation, coupled with moisture that might be trapped inside the cap and/or precipitation such as rain, snow, or ice that might be covering the cap, renders visual readings even more prone to errors. Such errors, coupled with the non-linearity of fuel amount remaining as a function of fuel level remaining, make traditional tank readings of marginal value at best.

### SUMMARY OF THE INVENTION

The disclosed wireless fuel sensor overcomes the above-noted deficiencies associated with prior-art fluid-level gauges. In particular, the disclosed fuel sensor supplants the existing dial gauge of an otherwise-conventional fluid-level-measuring mechanism, either by replacing it altogether or simply by fitting over a preexisting one.

To that end, an embodiment of the disclosed wireless fuel sensor has a magnetic-field-sensor such as a Hall-effect rotary encoder that detects the angular position of the drive magnet at the top of the float-mechanism driveshaft. The sensor transmits fuel-remaining information wirelessly to a common, multifunctional consumer computing device—such as a smartphone, a tablet computer, a laptop computer, or a desktop computer that runs an app or an application (referred to collectively herein as an app), or even a home automation controller, by which the user is able to determine (read) the amount of fuel remaining in his or her propane cylinder(s) in terms of actual volume of fuel remaining—without needing to visit the tank and without having to perform complex mathematical calculations to account for tank geometry and/or temperature-caused fluctuations. Rather, conversion between fluid level and fluid volume is handled automatically and preferably “onboard” by the sensor's microcontroller.

Furthermore, the sensor includes an onboard temperature transducer that measures temperature of the liquid propane tank. Temperature information is used, preferably by the sensor's microcontroller, to compensate for fluid-level fluctuations with changing fluid temperatures.

Thus, in one aspect, the invention features a wireless, fuel-remaining sensor. The sensor operates in conjunction with the tank flange of a liquid-propane cylinder having a conventional, float-based mechanism as described above, i.e., one in which a magnet rotates with changing levels of liquid propane in the cylinder. The sensor further operates in conjunction with an app that runs on a multipurpose, consumer computing device as exemplified by those devices mentioned above. The fuel-remaining sensor includes a microprocessor; a magnetic-field-sensing device, which is configured to detect the orientation of the magnet as it rotates with changing levels of liquid propane in the cylinder; and a signal-transmitting antenna.

The microprocessor receives from the magnetic-field-sensing device information as to the orientation of the magnet, and it is programmed to calculate from that orientation information, using information as to the geometry of the cylinder, volumetric fuel-remaining information. The microprocessor transmits the volumetric fuel-remaining information to the computing device, via the signal-transmitting antenna, for display or other processing via the app.

In another aspect, the invention features a wireless, fuel-remaining sensor. The sensor operates in conjunction with the tank flange of a liquid-propane cylinder having a conventional, float-based mechanism as described above, i.e., one in which a magnet rotates with changing levels of liquid propane in the cylinder. The sensor further operates in conjunction with an app that runs on a multipurpose, consumer computing device as exemplified by those devices mentioned above. The fuel-remaining sensor includes a microprocessor; a magnetic-field-sensing device, which is configured to detect the orientation of the magnet as it rotates with changing levels of liquid propane in the cylinder; a temperature sensor, which is configured and disposed to detect the temperature of the tank flange; and a signal-transmitting antenna.

The microprocessor receives from the magnetic-field-sensing device information as to the orientation of the magnet, and it is programmed to calculate from that orientation information fuel-remaining information. The microprocessor is further programmed to calculate, using the sensed temperature of the tank flange, a fuel-remaining correction amount attributable to fuel remaining in the cylinder in its vapor phase and to include that correction amount in the microprocessor's calculation of fuel-remaining information. The microprocessor transmits the fuel-remaining information to the computing device, via the signal-transmitting antenna, for display or other processing via the app.

### BRIEF DESCRIPTION OF THE DRAWINGS

The advantages and novel features of the invention will become apparent from the following description of the invention, below, in conjunction with the drawings in which:

FIGS. 1 and 2 are schematic drawings illustrating a gauge used to determine the fluid-level of liquid propane remaining in a cylinder according to the prior art;

FIGS. 3 and 4 are schematic diagrams illustrating one embodiment of a sensor used to determine and transmit wirelessly the amount (i.e., volume) of liquid propane remaining in a cylinder in accordance with the claimed invention;

FIGS. 5A, 5B, and 5C are perspective views of a conventional gauge head on a liquid-propane cylinder, illustrating the gauge head with a conventional, dial-type needle indicator (FIG. 5A); with the needle indicator removed (FIG. 5B); and with the positioning of electrical components according to the claimed invention illustrated schematically (FIG. 5C);

FIGS. 6 and 7 are a schematic bottom diagram and a schematic top diagram, respectively, of electrical components used in the gauge shown in FIGS. 3 and 4;

FIGS. 8, 8a, 8b, 8c, 8d, and 8e are schematic views illustrating electrical components used in the sensor shown in FIGS. 3 and 4 and their associated electrical interconnections, with FIG. 8a being an expanded view of the encircled portion 8a shown in FIG. 8; FIG. 8b being an expanded view of the encircled portion 8b shown in FIG. 8; FIG. 8c being an expanded view of the encircled portion 8c shown in FIG. 8; FIG. 8d being an expanded view of the encircled portion 8d shown in FIG. 8; and FIG. 8e being an expanded view of the encircled portion 8e shown in FIG. 8;

FIG. 9 is a schematic section view illustrating an alternate embodiment of a sensor used to determine and transmit wirelessly the amount of liquid propane remaining in a cylinder in accordance with the claimed invention; and

FIG. 10 is a schematic diagram illustrating an examplary user interface (e.g., an app) by means of which a user can determine the amount of liquid propane remaining in a cylinder as well as other useful information derived from that fuel-remaining information.

### EXAMPLARY EMBODIMENTS OF THE INVENTION

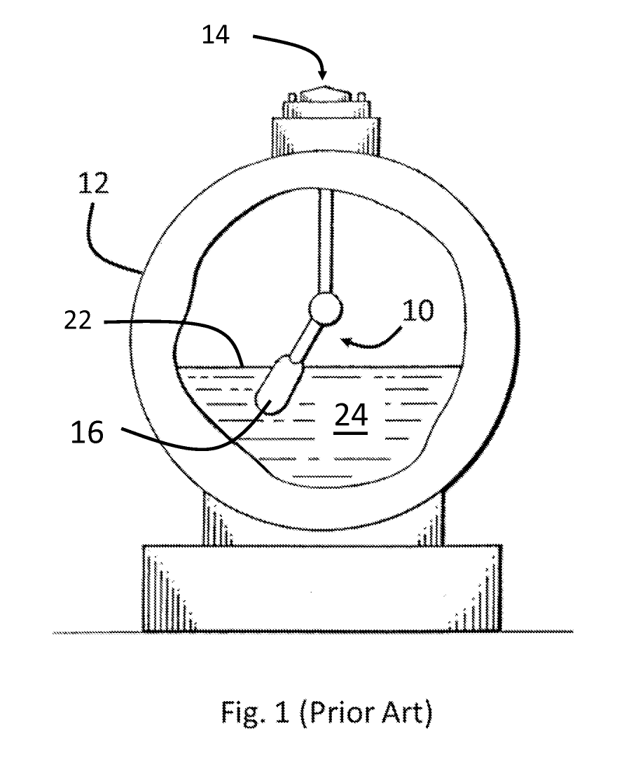

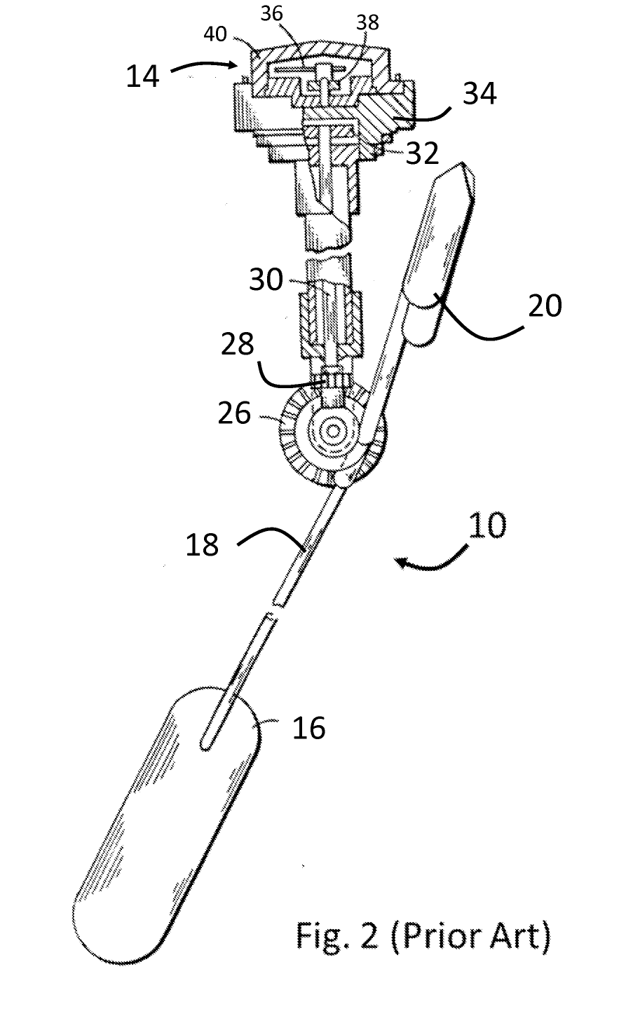

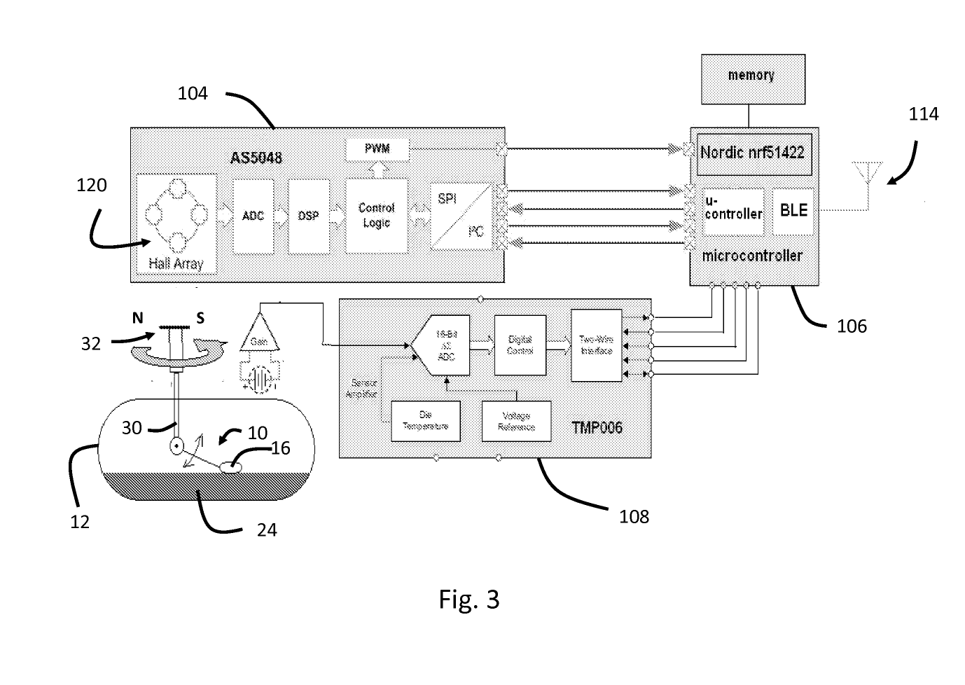

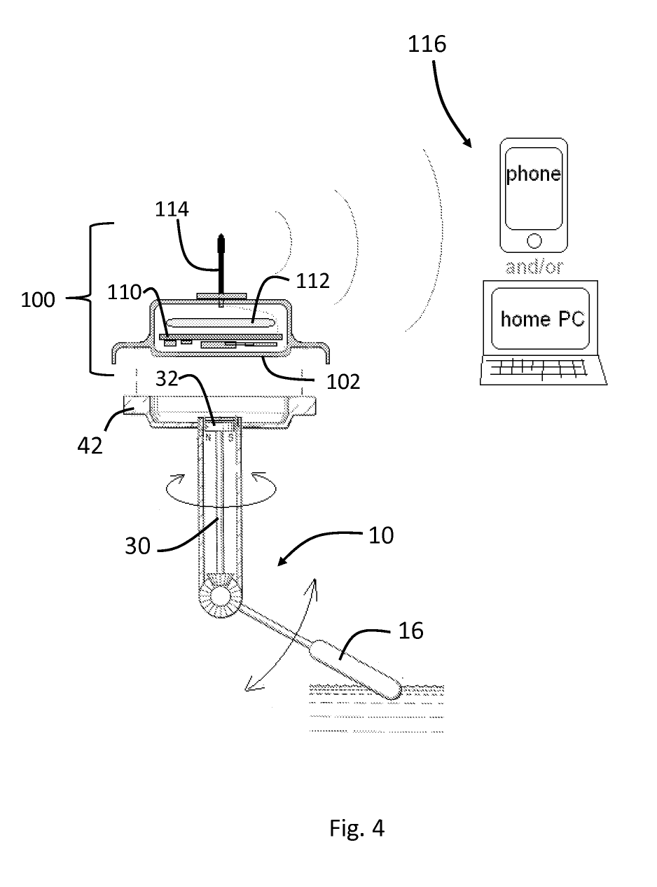

One embodiment of a wireless fuel sensor system in accordance with the claimed invention is illustrated in FIGS. 3-10. As shown in FIGS. 3 and 4, where reference numerals that are the same as those used in FIGS. 1 and 2 represent the same generic, prior-art structures as those described above, a fluid-amount-sensing gauge head 100 is suitably configured to operate in conjunction with the float mechanism 10 and, in particular, the drive magnet 32 of a conventional, possibly preexisting fluid-level-measuring gauge assembly. More particularly, the gauge head 100 includes a housing 102, which is suitably made from non-ferromagnetic, weather-resistant, and possibly radio-transmissive (depending on antenna configuration) material such as plastic, hard nylon, etc. The housing 102 contains therein electrical components, described below, and is shaped and configured to mate with the tank flange 34 of the conventional, possibly preexisting fluid-level-sensing gauge assembly in a liquid-propane cylinder 12.

In general, the gauge-head electrical components include a chip-based Hall-effect rotary encoder 104, a microcontroller 106, and a chip-based temperature sensor 108. Suitably, all of these electrical components are mounted to a single printed circuit board 110 and are powered by a low-voltage battery 112 such as a CR2032, lithium coin-cell battery, or other compact battery such as a standard 9-volt battery, in conjunction with a power-supply circuit 113. As addressed more fully below, the Hall-effect rotary encoder 104 is sensitive to the angular orientation of a magnetic field and therefore can be used to determine the angular position of the drive magnet 32. By determining the angular position of the drive magnet 32, it is possible to determine the position of the float 16 and, hence, the level of liquid propane 24 within the cylinder 12. The gauge head 100 then wirelessly transmits to a consumer, via antenna 114, information as to how much fuel remains in the cylinder 12 in terms of volume, e.g., gallons or liters. The volume information is received via a common, multifunctional consumer computing device 116 such as a smartphone, a tablet computer, a laptop computer, or a desktop computer that runs an app by which the user is able to determine the amount of fuel remaining in his or her propane cylinder(s), i.e., without needing to visit the tank to take a manual, visual reading of the gauge or perform complex, difficult conversion calculations. The transmitted information suitably may also include temperature of the propane; remaining power-level of the battery 112; and a time stamp.

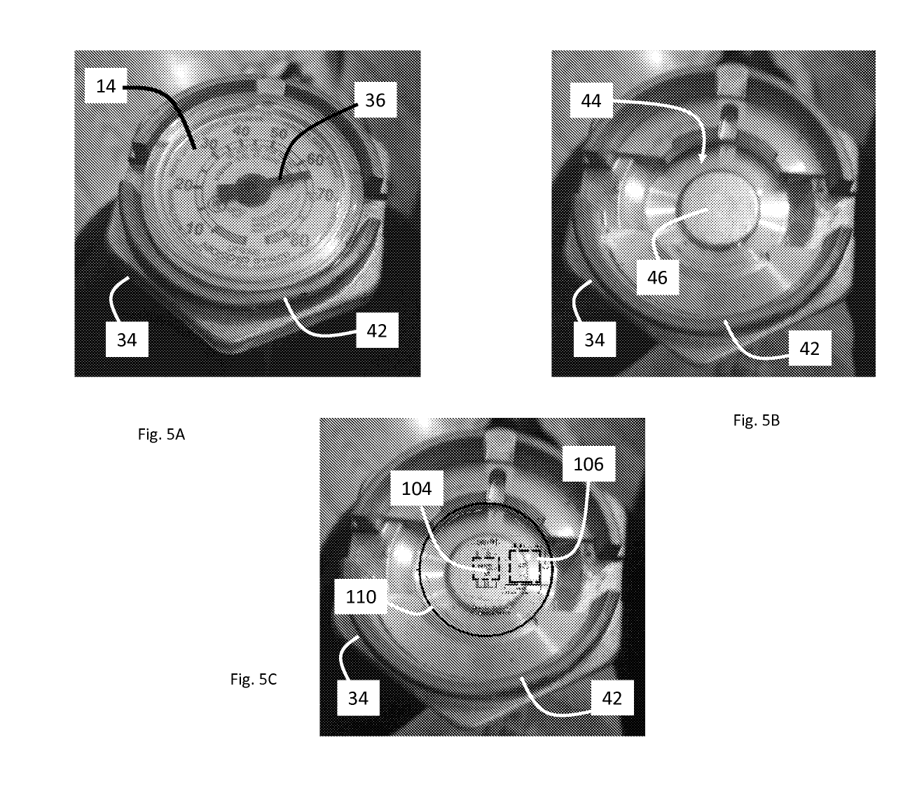

As illustrated in FIGS. 5A, 5B, and 5C, the conventional tank flange 34 has a generally circular ridge 42 that forms a well or pocket into which the conventional needle-type gauge dial 14 fits. If the gauge dial 14 is removed, e.g., if an existing propane cylinder is being retrofitted to include a wireless fuel gauge in accordance with the present invention, a further recess or pocket 44 is revealed, with a smaller, slightly protuberant “button” or “pedestal” 46 centrally located within the recess or pocket 44; the drive magnet 32 is located beneath this button or pedestal 46. Therefore, the lower portion (at least) of the gauge-head housing 102 is configured to fit down within the recess or pocket 44 with the Hall-effect rotary encoder 104 centered over the button or pedestal 46, i.e., centered over the drive magnet 32.

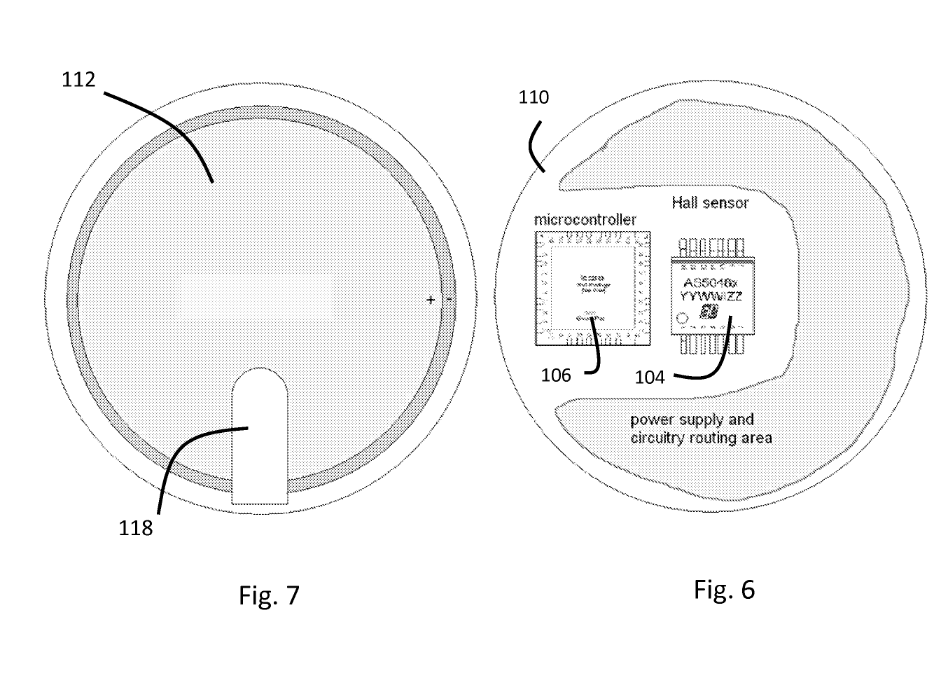

Thus, as illustrated in FIGS. 4, 5C, and more so in FIG. 6, the printed circuit board 110 is suitably round, with the Hall-effect r 104 centrally mounted to the underside of the printed circuit board 110 (i.e., the side of the printed circuit board 110 that is closest to the propane cylinder 12) along with the temperature sensor 108 (not shown in FIG. 4, 5C, or 6), and both are suitably potted/encapsulated. The other electrical components may be located on the underside of the printed circuit board 110, too, or, suitably, are mounted to the top surface of the printed circuit board 110 to avoid crowding of the various components; these other electrical components are also suitably potted/encapsulated. An electrical contact pad (not shown) is provided in position to make electrical contact with one surface of the coin-cell battery 112, and a flexible, finger-shaped metal contact 118 is provided to make electrical contact with the opposite surface of the coin-cell battery 112 as shown in FIG. 7, which opposite surface is of opposite polarity to the first surface of the coin-cell battery 112.

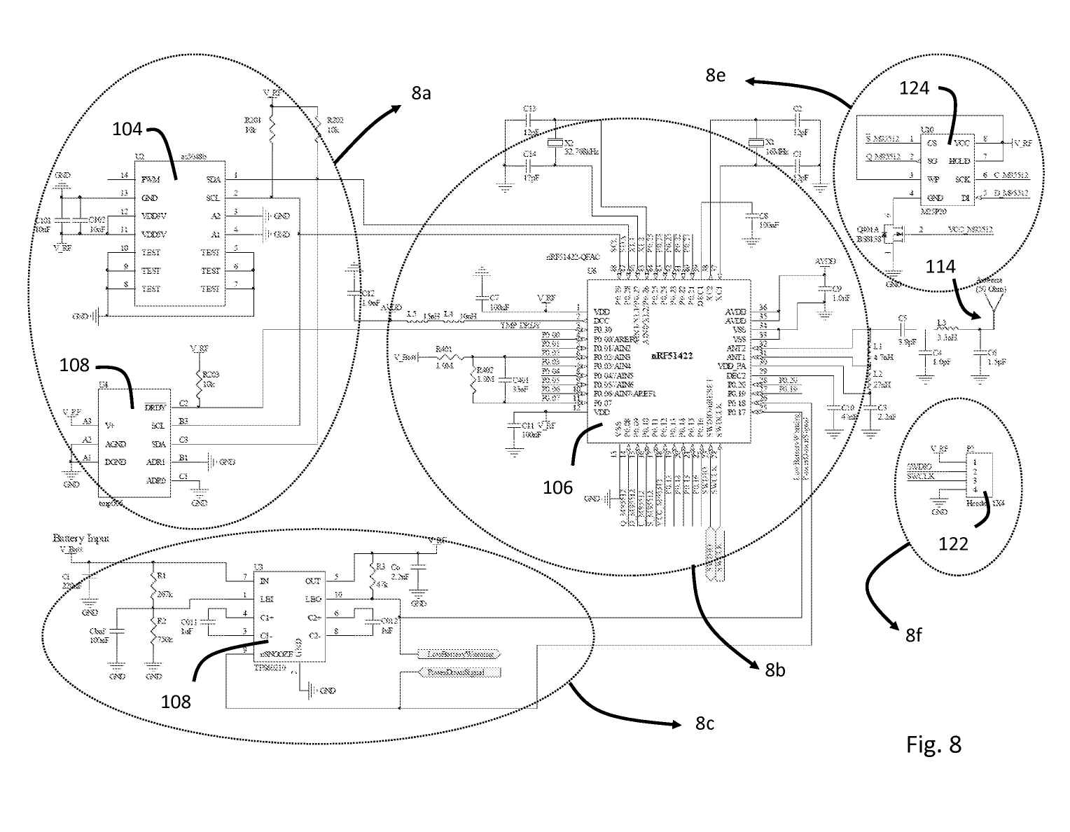

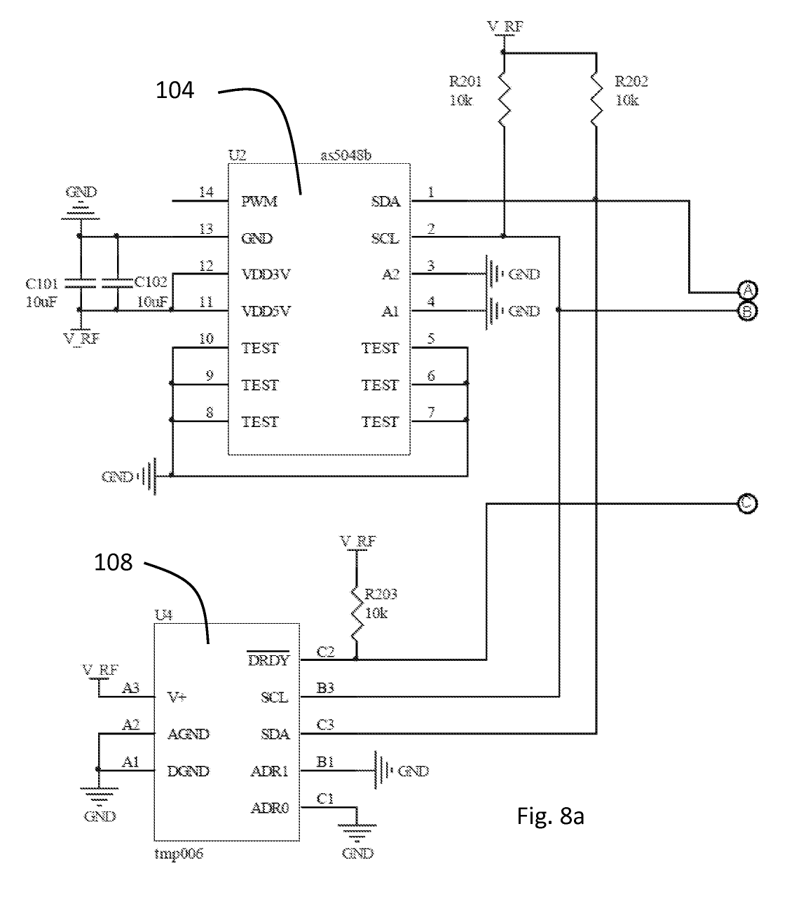

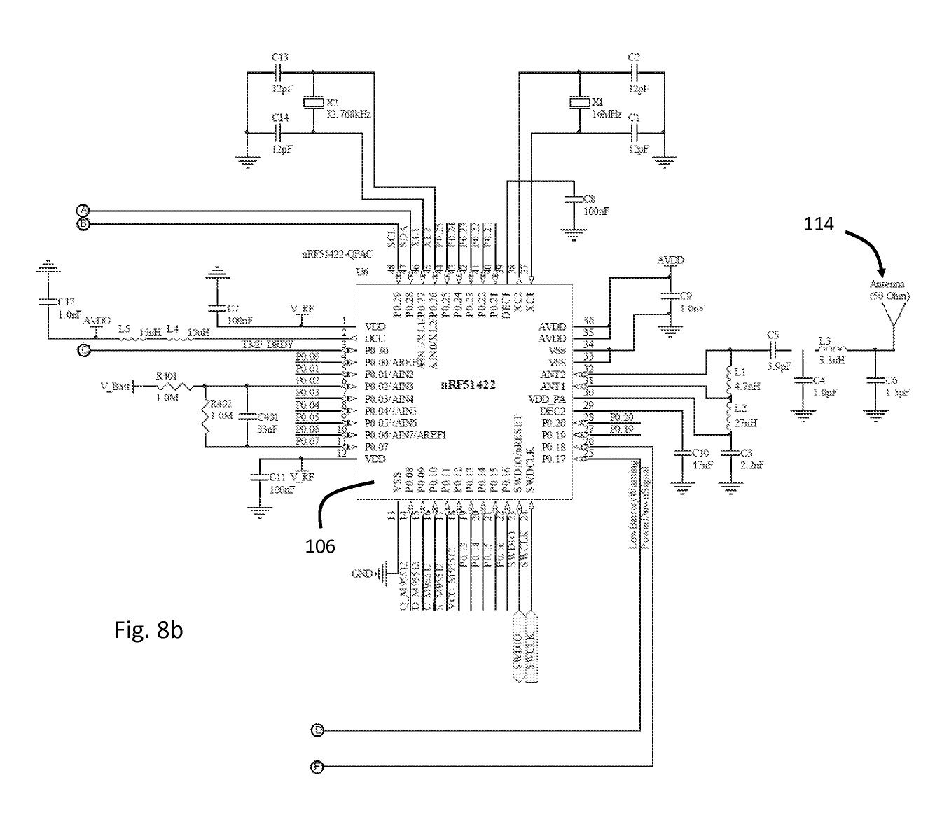

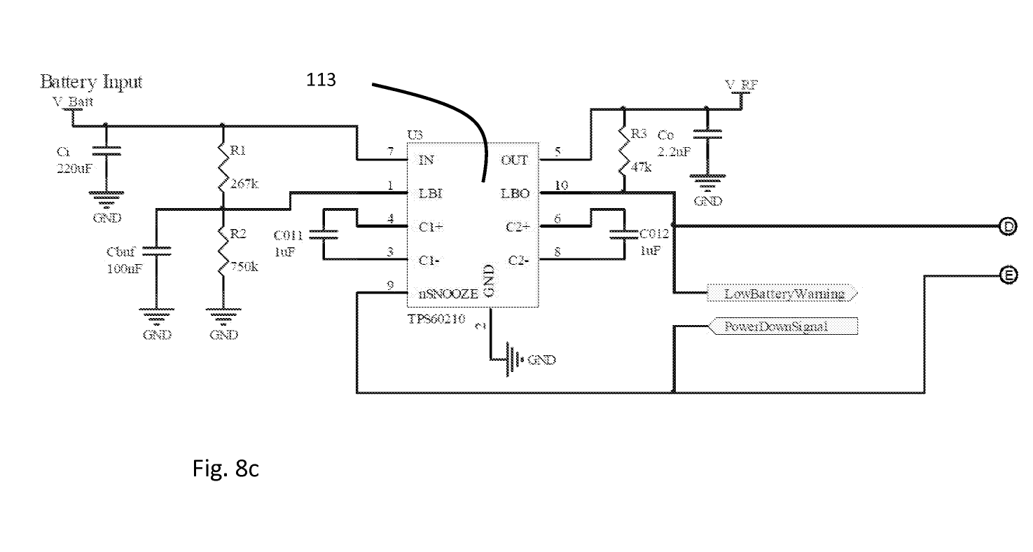

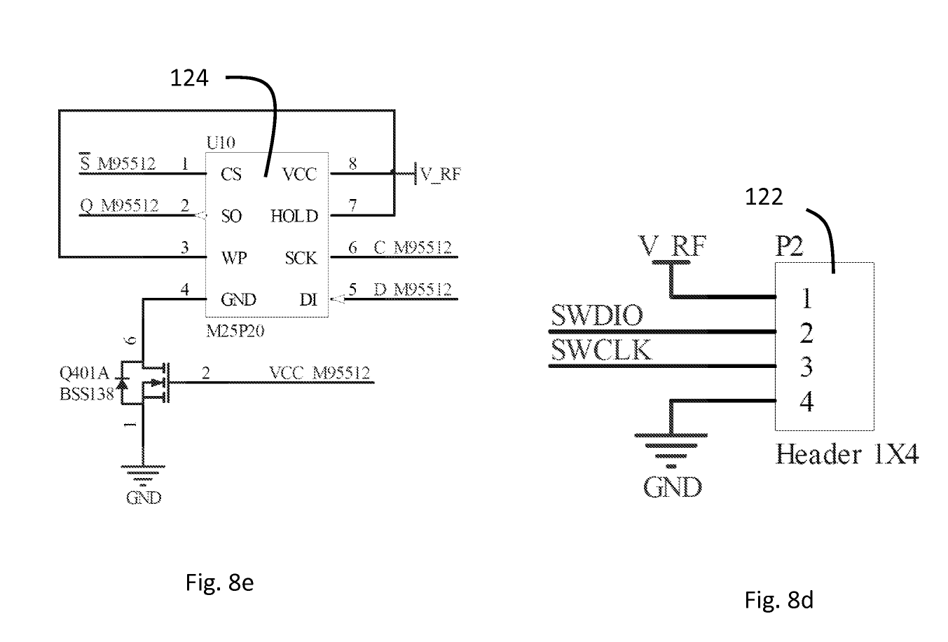

Further details as to the electrical components and, in particular, the manner in which they are interconnected via the printed circuit board 110 are illustrated in FIGS. 8, 8a, 8b, 8c, 8d, and 8e for one exemplary embodiment of a gauge head 100 in accordance with the claimed invention. According to this particular embodiment, the Hall-effect rotary encoder 104 is suitably an AS5048B chip-based device, which is a 14-bit rotary position encoder available from ams AG (formerly austriamicrosystems AG) of Unterpremstaetten, Austria. Notably, the AS5048B device has an array 120 of four discrete Hall-effect sensing elements arranged 90° apart from each other around a center-point (to coincide with the center of rotation of the component being monitored), as illustrated in FIG. 3, and this enhances the positional sensing capability of the device.

Overall operation of the gauge head 100 is controlled by microcontroller 106, which, according to this embodiment, is an nRF51422 microcontroller available from Nordic Semiconductor of Oslo, Norway. Notably, this particular microcontroller features so-called “system-on-a-chip” (or “SoC”) architecture as well as ANT and Bluetooth® Smart (previously called Bluetooth low-energy or BLE) ultra-low-power wireless transmission capabilities, which make it well suited for use in the context of the present invention. This is particularly true where multiple propane cylinders are linked together to provide a combined source of fuel, since the ANT technology allows multiple chips to “talk to” each other and thus enables a single, combined total value of fuel remaining to be transmitted to the consumer. It also facilitates increased range through device-to-device relay of information, if needed, for large, multi-tank installations.

As indicated above, the gauge head 100 is configured to measure the temperature of the liquid propane in order to compensate for temperature-based fluctuation in the measured volume of fluid remaining More particularly, the system accounts for the fact that at warmer temperatures, a greater proportion of propane within the tank will have “boiled off” and exist in the vapor phase. (Pressure in the tank will rise at the same time.) Although that vapor portion of the propane in the tank is still available to be used as fuel, the level of propane in the tank in liquid form will drop, thereby causing the float 16 to drop and indicate a lower amount of propane remaining than is actually the case. Therefore, if the temperature of the propane is known, the amount of propane that has been “lost” to the vapor phase can be calculated and added back to the amount of propane that remains as determined from the level of the liquid propane in the tank.

To that end, the sensor-system head 100 includes the chip-based temperature transducer 108, which, in the case of the illustrated embodiment, is a TMP006, contactless infrared thermopile temperature transducer available from Texas Instruments of Dallas, Tex. In general, the temperature of the tank flange 34 is a suitable proxy for the temperature of the thermal mass of liquid propane 24 since the tank flange 34 is in thermal contact with the liquid propane 24 through the float mechanism 10. Therefore, the temperature sensor 108 is positioned and oriented on the printed circuit board 110 so as to measure the temperature of the tank flange 34. If the temperature sensor 108 is potted/encapsulated in IR-transmissive material (specifically in the 4-micron to 8-micron wavelength at which the TMP006 sensor operates), the sensor 108 will be able to “see” the tank flange 34 and “read” its temperature through the potting/encapsulating material. Otherwise, if the potting/encapsulating material is opaque to radiation at such wavelengths, an IR-transmissive “window” through which the sensor can “see,” e.g., a window made from sapphire or other IR-transmissive materials, could be provided to allow the sensor to see and sense the temperature of the tank flange 34.

The power-supply circuit 113 may be formed with a TPS60210, low-ripple charge pump, which is also available from Texas Instruments.

With respect to the antenna 114, the particular type and configuration of it depends largely on factors such as desired transmission range and system simplicity. Suitably, however, it is configured to transmit and receive generally in the vicinity of 2.4 GHz, i.e., the frequency range at which Bluetooth®-enabled and/or Wi-Fi-enabled wireless devices transmit. Thus, for example, the antenna 114 may be very tiny, e.g., formed as an internal trace printed on the printed circuit board 110, if the gauge head 100 is to be used on a propane cylinder that is located as close to a building as regulations permit. Alternatively, if greater transmission range is required (e.g., where the propane cylinder is located near a propane-heated farm out-building that is a distance away from the farmer's residence), a separate, standalone antenna with, for example, 2 db, 5 db, or even 7 db output could be used. In that case, the system could be configured with an antenna-cable connector such as an MMCX connector through which the antenna 106 is electrically connected to the printed circuit board 110 and, hence, to the microcontroller 106. Moreover in that case, it would preferable for the antenna 106 to be positioned outside of the hinged metal dome shroud that typically covers the fuel gauge on a liquid-propane cylinder, with the antenna cable passing through the dome shroud and the antenna 106 secured to the cylinder or the dome shroud via a magnetic base, since the metal dome shroud can attenuate the signal to some extent. (Alternatively, particularly where the propane cylinders are located at least partially underground and the area is subject to large amounts of snowfall, the antenna could be mounted on a mast at some height above the ground so as to keep its signal largely unimpeded.)

Finally with respect to the electrical components, a 1×4 microcontroller header 122 is connected to the printed circuit board 110, in electrical contact with the microcontroller 106, to facilitate programming of and otherwise loading programming code onto the microcontroller 106. Additionally, memory capability may optionally be provided (e.g., to maintain historical information as determined by the gauge head) by means of memory chip 124, which may be, for example, an M25P20 serial flash embedded memory chip available from Micron Technologies, Inc. of Boise, Id.

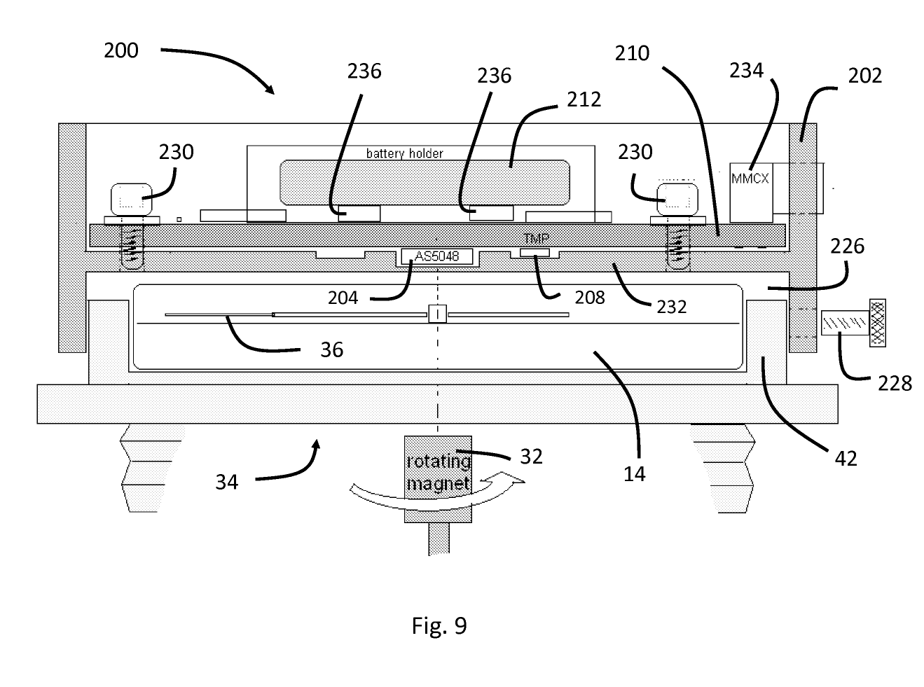

As noted above, a wireless gauge head in accordance with the claimed invention might be configured simply to fit over the preexisting gauge head on a liquid-propane tank that is configured as per the prior art, and such an alternate embodiment 200 is illustrated schematically in FIG. 9. The various components of the gauge head 200 are generally the same as the various components described above; therefore, where the components have been described previously, they are labeled with the same reference number but incremented by 100 and extensive further description of the components is not provided below.

It is noted, however, that in this embodiment 200, the recessed bottom portion 226 (at least) of the circular housing 202 is deep enough, and it has an inside diameter large enough, to permit the gauge head 200 to fit over the ridge 42 of the tank flange 34 as well as the conventional gauge dial 14 located within the ridge 42. In general, it has been found that this arrangement brings the Hall-effect sensor 204 into close enough proximity to the drive magnet 32 and any slave magnet (not illustrated) for the gauge head 200 to determine the angular position of the magnet(s) with sufficient accuracy to determine the volume of liquid propane remaining in the cylinder.

Suitably, this embodiment 200 of a wireless gauge head may include one or more positioning screws 228 located circumferentially around the bottom portion of the housing 202. The positioning screws can be threaded into and through the sidewalls of the sensor housing to better position and secure the sensor head relative to the drive magnet 32, thereby enhancing the measurement accuracy of the device. Hex screws 230 or similar fasteners are used to secure the printed circuit board 210 to web 232 of the housing 202. Other components illustrated in FIG. 9, which are alluded to above but not shown in the previously described figures, include MMCX antenna-cable connector 234 as well as contact pads 236, which make electrical contact with the underside of the underside of the battery 212.

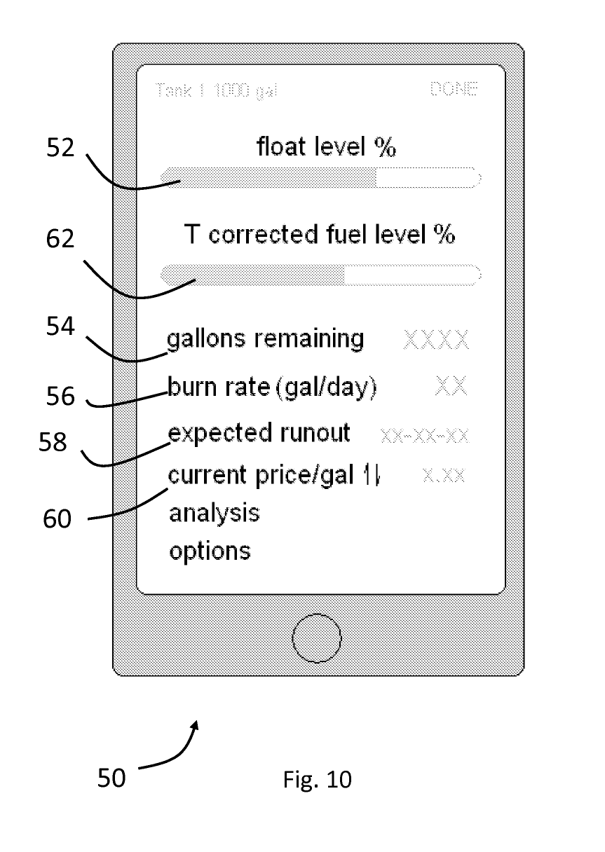

As noted above and indicated schematically in FIG. 4, a wireless gauge head in accordance with the claimed invention transmits fuel-remaining information to a common, multifunctional consumer computing device such as a smartphone, a tablet computer, a laptop computer, or a desktop computer that runs an app configured to display that information. For example, as shown in FIG. 10, an app running on a smartphone 50 may display information 52 as to propane remaining within a given cylinder in terms of the surface level of the liquid propane, as a percentage of maximum surface level.

As explained above, however, given the circular nature of propane cylinders, the percentage of fuel remaining as expressed in terms of the maximum surface level of the liquid propane is not the same as the percentage of fuel remaining as expressed in terms of actual volume (e.g., gallons or liters). Therefore, the app also displays fuel-remaining information 54 in terms of actual volume of fuel remaining With this information, not only will the consumer know how much fuel remains, but he or she will also know correctly the percentage of fuel that remains to be used. For example, if a 500-gallon cylinder contains 100 gallons of propane, the consumer will know that 80% of the supply has been consumed and that only 20% of the supply—not some other, less-informative value referring to the height of the liquid—remains. (Given the greater usefulness of volume-remaining information, it is contemplated that the system might be configured to provide only that information to the user.)

Furthermore, it will be understood by one of skill in the art that the volume of fluid in the cylinder can be calculated from the surface level information for the fluid in the cylinder. That calculation is not, however, easy, and it is certainly not the sort of calculation that can be performed readily by the large majority of the public; therefore, the system according to the invention performs the calculation and displays the more-meaningful volume-remaining information for the consumer.

In this regard, the volume calculation could be performed by the app running on the smartphone 50 or other multifunctional consumer computing device. However, from a design perspective, it is preferred that the gauge-head microcontroller performs the calculation onboard and transmits the volume information as such (either with or without associated fluid-level information) to the receiving app.

To perform this calculation, of course, the microcontroller must have information as to the geometry of the propane cylinder being monitored, and that information could be hard-coded into the microcontroller. Alternatively, when the user runs the associated app for the first time, the app will ask the user what size tank he or she has and it will then “know” the tank geometry as well as its capacity since propane tanks are manufactured according to standard, ASME pressure-vessel configurations.

As further noted above, it is not uncommon for multiple propane cylinders to be plumbed together to provide an aggregated fuel supply. To accommodate that situation, the app could be configured to communicate with multiple wireless sensor heads, with each one being given its own unique identifier, so as to monitor the aggregate fuel supply as well as the fuel supply in individual tanks within the set. In this regard, summation of fluid volumes could be performed fairly easily by the app. However, as noted above, the nRF51422 microcontroller includes ANT wireless technology and protocols such that multiple controllers can communicate with each other and share remaining-fuel information (or act as individual, distance-relay units). Therefore, total fuel remaining could be determined by the various microcontrollers and transmitted to the app, e.g., via a “master” microcontroller, instead of the app being relied upon to calculate the sum. This arrangement is, in fact, particularly well-suited to accommodate a situation in which the various propane cylinders are so widely distributed that some units are too far away from the receiving unit for their signals to be detected by the receiving unit; as long as all of the gauge heads are able to communicate with at least one other gauge head, composite information can be assembled and transmitted to the app via the closest, presumably master microcontroller.

Further still, using usage information that has been tracked either at the microcontroller or in the app, the app is able to display burn rate information 56 (e.g., gallons consumed per day) as well as the date 58 on which, at the current rate of consumption, it is predicted that fuel will be completely consumed. Additionally, the app is able to access via the Internet and display current price information 60; with this information and knowing accurately how much fuel remains within the propane cylinder(s), a consumer is better able to manage his or her use of propane and what he or she spends in order to refuel.

Finally, as explained above, the gauge head includes a temperature sensor, which measures the temperature of the tank flange as a proxy for the temperature of the liquid propane. Preferably the microcontroller, per se, uses that temperature data to correct for temperature-related fluctuation in sensed fluid levels; alternatively, the temperature data may be transmitted to the app along with the other fluid-remaining data, and the app could perform the temperature-correction calculations instead. Either way, temperature-corrected data 62 may also be displayed along with the other information. The app can also access projected weather reports and historical weather data for the local area to estimate, in degree-days, against use rate. With that information, the app is able to make predictive recommendations to users on expected weather trending and help the user make financial decisions to refill against often-rapidly fluctuating fuel prices during seasonal transitions.

The foregoing disclosure of various embodiments is intended to be by way of example only. Various modifications to and departures from the disclosed embodiments may occur to those having skill in the art without departing from the inventive concepts disclosed herein. Therefore, the scope of the invention is set forth in the following claims.

We claim:

1. A wireless, fuel-remaining sensor that operates in conjunction with 1) the tank flange of a liquid-propane cylinder having a float mechanism in which a magnet rotates with changing levels of liquid propane in the cylinder, and 2) an app that runs on a multipurpose, consumer computing device, the fuel-remaining sensor comprising:
a microprocessor;
a magnetic-field-sensing device, which is configured to detect the orientation of the magnet as it rotates with changing levels of liquid propane in the cylinder; and
a signal-transmitting antenna;
wherein the microprocessor receives from the magnetic-field-sensing device information as to the orientation of the magnet and is programmed to calculate from said orientation information, using information as to the geometry of the cylinder, volumetric fuel-remaining information; and
wherein the microprocessor transmits the volumetric fuel-remaining information to the computing device, via the signal-transmitting antenna, for display or other processing via the app.

2. The fuel-remaining sensor of claim 1, wherein the volumetric fuel-remaining information is expressed as the volume of fuel remaining in the cylinder in liquid form.

3. The fuel-remaining sensor of claim 1, wherein the volumetric fuel-remaining information is expressed as a percentage of the maximum liquid volume of fuel which remains in the cylinder in liquid form.

4. The fuel-remaining sensor of claim 1, wherein the magnetic-field-sensing device is a Hall-effect sensor that is positioned within the sensor so as to be centered with respect to the magnet when the sensor is positioned in sensing relationship to the tank flange.

5. The fuel-remaining sensor of claim 1, wherein the microprocessor transmits the volumetric fuel-remaining information using Bluetooth® and/or Wi-Fi wireless transmission protocols.

6. The fuel-remaining sensor of claim 1, wherein the microprocessor, the magnetic-field-sensing device, and the signal-transmitting antenna are all contained within a single housing, which housing is sized and configured to mate with the tank flange.

7. The fuel-remaining sensor of claim 6, wherein the sensor is battery-powered.

8. The fuel-remaining sensor of claim 7, wherein the sensor is configured to be powered by a coin-cell battery.

9. A wireless, fuel-remaining sensor that operates in conjunction with 1) the tank flange of a liquid-propane cylinder having a float mechanism in which a magnet rotates with changing levels of liquid propane in the cylinder, and 2) an app that runs on a multipurpose, consumer computing device, the fuel-remaining sensor comprising:
a microprocessor;
a magnetic-field-sensing device, which is configured to detect the orientation of the magnet as it rotates with changing levels of liquid propane in the cylinder;
a temperature sensor, which is configured and disposed to detect the temperature of the tank flange; and
a signal-transmitting antenna;
wherein the microprocessor receives from the magnetic-field-sensing device information as to the orientation of the magnet and is programmed to calculate from said orientation information fuel-remaining information;
wherein the microprocessor is programmed to calculate, using the sensed temperature of the tank flange, a fuel-remaining correction amount attributable to fuel remaining in the cylinder in its vapor phase and to include said correction amount in the microprocessor's calculation of fuel-remaining information; and
wherein the microprocessor transmits the fuel-remaining information to the computing device, via the signal-transmitting antenna, for display or other processing via the app.

10. The fuel-remaining sensor of claim 9, wherein the magnetic-field-sensing device is a Hall-effect sensor that is positioned within the sensor so as to be centered with respect to the magnet when the sensor is positioned in sensing relationship to the tank flange.

11. The fuel-remaining sensor of claim 9, wherein the microprocessor transmits the volumetric fuel-remaining information using Bluetooth® and/or WiFi wireless transmission protocols.

12. The fuel-remaining sensor of claim 9, wherein the microprocessor, the magnetic-field-sensing device, the temperature sensor, and the signal-transmitting antenna are all contained within a single housing, which housing is sized and configured to mate with the tank flange.

13. The fuel-remaining sensor of claim 12, wherein the sensor is battery-powered.

14. The fuel-remaining sensor of claim 13, wherein the sensor is configured to be powered by a coin-cell battery.
